(19) United States
(12) Patent Application Publication
(10) Pub. No.: US 2020/0111287 A1
(43) Pub. Date: Apr. 9, 2020

(54) INFORMATION PROCESSOR, RECORDING MEDIUM, AND GAME CONTROL METHOD

(71) Applicant: Universal Entertainment Corporation, Tokyo (JP)

(72) Inventors: Masaki OYAMA, Tokyo (JP); Toshikazu JINNOUCHI, Tokyo (JP)

(21) Appl. No.: 16/588,042

(22) Filed: Sep. 30, 2019

(30) Foreign Application Priority Data
Oct. 5, 2018 (JP) 2018-190209

(51) Int. Cl. G07F 17/32

(52) U.S. Cl. CPC G07F 17/3211; G07F 17/3216; G07F 17/3244; G07F 17/3209

(57) ABSTRACT

An information processor displays a slot game on a display and stores a normal effect and a high-speed effect in which the normal effect is reproduced at higher speed than the normal effect, in association with a game result. The information processor internally and randomly determines the game result of the slot game, selects the normal effect associated with the game result and displays the normal effect on the display when an item for acceleration has not been used, and selects a high-speed effect and displays the high-speed effect on the display when the item for acceleration has been used.

### CROSS-REFERENCE TO RELATED APPLICATION

This application is entitled to the benefit of Japanese Patent Application No. 2018-190209 filed on Oct. 5, 2018.

### FIELD I/F THE INVENTION

The present invention relates to an information processor, a recording medium, and a game control method.

### BACKGROUND I/F THE INVENTION

There are slot games in which rotation of reels start and stop in order so that a game result is presented. In such a slot game, typically, random determination is performed to determine a game result immediately after the start of the game, and an effect based on the result of the random determination is performed until the game result is presented on a display, etc. For example, in Japanese Laid-Open Patent Publication No. 2013-153870, until a game result is displayed, an effect of variously changing light emission of a backlight of a mechanical reel unit is performed while reels are rotating, based on a game result determined in advance. As such, because a game result is presented after at least a reel rotation effect is performed, execution of a slot game once takes a predetermined time.

Meanwhile, Japanese Laid-Open Patent Publication No. 2015-217021 and Japanese Laid-Open Patent Publication No. 2017-136255 disclose ways to shorten the time taken by a game. Japanese Laid-Open Patent Publication No. 2015-217021 teaches that a time shortening item is given to a player. This time shortening item shortens a synthesis time required to develop a base block which changes a parameter value of a player character based on shape, by synthesizing an element block with the base block. Japanese Laid-Open Patent Publication No. 2017-136255 recites that a game content is consumed to shorten the time required for evolution of a character which evolves in terms of level over time.

### BRIEF SUMMARY I/F THE INVENTION

There is a certain percentage of users of a slot game who wish to increase the number of game play per unit time by accelerating game progress, and such users may not need effects. However, as described above, the effects include an important effect indicating a game result. Furthermore, some users may enjoy the effects. For these reasons, the technologies recited in Japanese Laid-Open Patent Publication No. 2015-217021 and Japanese Laid-Open Patent Publication No. 2017-136255 in which added time is simply shortened to advantageously progress a game cannot be employed. A problem to be solved is therefore how to shorten the time required to play a game.

An object of the present invention is to provide an information processor, a recording medium, and a game control method, by which a game advances more quickly than usual.

An information processor of the present invention includes:

a display configured to display a slot game;
a memory configured to store a normal effect and a high-speed effect in which the normal effect is reproduced at higher speed than the normal effect, in association with a game result; and
a controller, the controller being programmed to execute the processes of:
internally and randomly determining a game result of the slot game;
when a predetermined condition is not satisfied, selecting the normal effect associated with the game result and displaying the normal effect on the display; and
when the predetermined condition is satisfied, selecting the high-speed effect associated with the game result and displaying the high-speed effect on the display.

According to the arrangement above, an effect is displayed at a higher speed than usual when the predetermined condition is satisfied. As a result, single execution of the slot game is finished earlier than usual. Consequently, the number of times of execution of the slot game per unit time is increased without omitting the effects, and the game progress is speedier than usual.

The information processor of the present invention may be adapted so that the predetermined condition is use of an item usable in the slot game by a user.

According to the arrangement above, the effect is accelerated when the item is used by the user. On this account, whether to accelerate the effect can be determined by the user.

The memory may store high-speed effects of different types for the normal effect, and The controller may select one of the high-speed effects associated with the game result, in accordance with the item used by the user.

According to the arrangement above, there are plural types of items, and the acceleration of an effect is changed in accordance with the item used by the user. This allows the user to play the slot game with an effect with desired speed.

The information processor of the present invention may be adapted so that an effect displayed in the slot game is constituted by a plurality of effect elements, and when the predetermined condition is satisfied, the controller selects an effect element for which the high-speed effect is displayed, from the effect elements.

According to the arrangement above, an effect displayed in single execution of the slot game is constituted by a plurality of effect elements, and whether to display the high-speed effect is determined for each effect element, when the predetermined condition is satisfied. On this account, it is possible to increase or decrease the number of effect elements for each of which the high-speed effect is performed, in accordance with a satisfied condition. It is therefore possible to set the time required for the slot game in accordance with a condition.

A recording medium of the present invention is

a non-transitory computer readable recording medium storing a game program,
the game program causing
a computer including a display and a memory to execute the processes of:
displaying a slot game on the display;
storing, in the memory, a normal effect and a high-speed effect in which the normal effect is reproduced at higher speed than the normal effect, in association with a game result;
internally and randomly determining a game result of the slot game;
when a predetermined condition is not satisfied, selecting the normal effect associated with the game result and displaying the normal effect on the display; and
when the predetermined condition is satisfied, selecting the high-speed effect associated with the game result and displaying the high-speed effect on the display.

According to the arrangement above, an effect is displayed at a higher speed than usual when the predetermined condition is satisfied. As a result, single execution of the slot game is finished earlier than usual. Consequently, the number of times of execution of the slot game per unit time is increased without omitting the effects, and the game progress is speedier than usual.

A game control method of the present invention is

a game control method executed by a computer including a display on which a slot game is displayed and a memory configured to store a normal effect and a high-speed effect in which the normal effect is reproduced at higher speed than the normal effect, in association with a game result, the method comprising the steps of:
internally and randomly determining a game result of the slot game;
when a predetermined condition is not satisfied, selecting the normal effect associated with the game result and displaying the normal effect on the display; and
when the predetermined condition is satisfied, selecting the high-speed effect associated with the game result and displaying the high-speed effect on the display.

According to the arrangement above, an effect is displayed at a higher speed than usual when the predetermined condition is satisfied. As a result, single execution of the slot game is finished earlier than usual. Consequently, the number of times of execution of the slot game per unit time is increased without omitting the effects, and the game progress is speedier than usual.

The present invention makes it possible to advance a slot game more quickly than usual.

### BRIEF DESCRIPTION I/F THE DRAWINGS

FIG. 1 illustrates the outline of an information processor.

FIG. 2 is a block diagram of the electrical configuration of the information processor.

FIG. 3 is a functional block diagram of the information processor.

FIG. 4 shows the outline of acceleration in a slot game.

FIG. 5 illustrates an effect element table.

FIG. 6 illustrates an acceleration correspondence table.

FIG. 7 is a flowchart of a slot game process.

FIG. 8 is a flowchart of a bonus game process.

FIG. 9 is a flowchart of an effect speed determination process.

FIG. 10 is a flowchart of an acceleration item management process.

### DETAILED DESCRIPTION I/F THE PREFERRED EMBODIMENT

A game system of the present invention will be described with reference to figures.

(Outline)

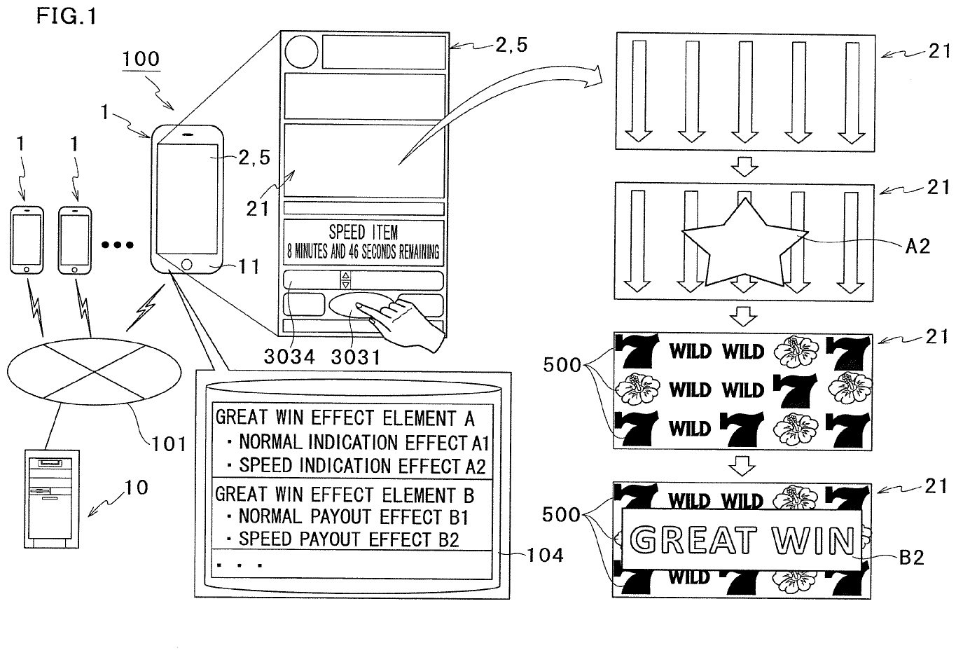

As shown in FIG. 1, an information processor 1 is arranged such that an animation indicating a win is reproduced at high speed when a predetermined condition is satisfied.

The information processor 1 is connected to a server 10 in a data-communicable manner via the Internet 101, thereby constituting a game system 100 including the information processor 1 and the server 10. It should be noted that the game system 100 is not limited to this, and the system may be constituted only by the information processor 1. Furthermore, the information processor 1 may indicate a game system including a terminal device such as a smartphone and a server. Functions of the information processor 1 which will be described in the present embodiment may be performed by any component of the game system.

In information processors 1, shared application software is installed from an application software server or the like corresponding to the OS (Operating System) of each information processor 1. In the present embodiment, a slot game is playable as a game element of the application software installed in the information processor 1. In other words, the user is allowed to play the slot game on this application software. The slot game may be an add-in of the application software. In other words, as an additional function of the application software, the slot game may be provided by an application software server, a server 10, etc. independently from the application software. The application software may allow the player to play plural types of slot games which are different in effects or rules. The application software may be a web browser.

The slot game starts on the premise of consumption of an accumulable gaming value. When a winning is achieved as a result of the slot game, a gaming value corresponding to the type of the winning and the consumed gaming value is added to the accumulated gaming value. As such, the information processor 1 executes the slot game in which the accumulable gaming value is increased or decreased in accordance with a result. The gaming value may be information (game point) which is used exclusively for starting the slot game and does not have a monetary value or may be electronic valuable information having a monetary value. Hereinafter, a gaming value which is a start condition of the slot game and an act of setting a gaming value may be termed a bet. Furthermore, a gaming value awarded as a game result of the slot game may be termed a payout.

As shown in FIG. 1, the information processor 1 of the present embodiment is a so-called smartphone. The information processor 1 includes a display 2 provided on the front surface of a housing 11 and a touch panel 5 provided throughout the display 2. The display 2 is provided with a symbol display area 21 in which symbols are varied and stopped after the start of the game.

To be more specific, the symbol display area 21 is provided with scroll areas as display frames. In each of the scroll areas, a video reel having a symbol array on which symbols are arranged is provided. When the slot game starts, the video reel scrolls and then stops in each of the scroll areas.

Each scroll area is formed of plural cells aligned in the up-down direction. In other words, cells are provided in the symbol display area 21 to form a matrix of plural columns by plural rows. When the symbols are rearranged, a symbol is displayed in each cell. While the borders between the cells are not clearly shown in the present embodiment, frames may be displayed on the borders between the cells, for example. Three cells are provided in each scroll area. In other words, a matrix of 5 columns and 3 rows is formed in the symbol display area 21. The disclosure, however, is not limited to this arrangement.

As described above, on the display 2, a play image of the slot game in which a video reel having a symbol array with symbols is scrolled and then stopped so that one or more of the symbols is rearranged is displayed in each of the five scroll areas in the symbol display area 21. On the display 2, furthermore, a play image in which a game result of the slot game is output in accordance with the arrangement of the symbols in the scroll areas is displayed.

In such a slot game, the information processor 1 internally and randomly determines symbols to be rearranged in the symbol display area 21, for each of the scroll areas in advance. In other words, the information processor 1 internally and randomly determines a game result of the slot game. Based on the random determination, the information processor 1 rearranges the symbols of the video reels in the scroll areas. As such, the information processor 1 executes a process of internally and randomly determining a game result of the slot game.

For example, on the display 2, the slot game progresses as described below. To be more specific, as shown in FIG. 1, in the information processor 1, a touch panel 5 which is an input device receives an input to a spin button 3031 displayed on the display 2. An amount of gaming value consumed in one execution of the slot game is set by an input to a bet button 3034, and is confirmed by an input to the spin button 3031. The information processor 1 then starts an effect of scrolling a symbol array in each scroll area of the symbol display area 21. The information processor 1 then stops the symbols in accordance with the symbol arrangement having been randomly determined, and displays a game result of the slot game. As such, the information processor 1 includes the display 2 on which the slot game is displayed.

As the slot game progresses, various effects are performed. For example, in FIG. 1, an indication effect A2 indicating a game result is displayed while the symbol array is scrolling in each scroll area. The indication effect may always be displayed when the corresponding game result will be achieved or the indication effect may be displayed at a predetermined probability when the corresponding game result will be achieved. The indication effect may be displayed when the corresponding game result will not be achieved.

Furthermore, for example, in FIG. 1, when a gaming value which is predetermined times or more as much as a gaming value consumed to start the slot game is awarded as a game result of the slot game, a payout effect B2 which indicates the awarding is displayed after the arrangement of the symbols.

These effects are stored in a flash memory 104 in the information processor 1 as shown in FIG. 1. The flash memory 104 which is a memory storing the effects of the slot game stores a normal effect and a high-speed effect in association with game results. The high-speed effect is an effect in which the normal effect is reproduced at high speed.

For example, as shown in FIG. 1, in the flash memory 104, an effect element A, an effect element B, and so on are set for a game result with which a gaming value predetermined times or more as much as a betted gaming value is awarded (hereinafter, such a game result may be simply referred to as GREAT WIN). In the case of the “GREAT WIN” game result, the effect element A is an indication effect whereas the effect element B is a payout effect. In this way, an effect displayed in the slot game is constituted by plural effect elements.

In the flash memory 104, a normal effect and a high-speed effect are stored in association with each effect element. When a predetermined condition is not satisfied, the information processor 1 selects a normal effect associated with a game result and displays the normal effect on the display 2. When the predetermined condition is satisfied, the information processor 1 selects a high-speed effect associated with a game result and displays the high-speed effect on the display.

For example, when the predetermined condition is not satisfied, the information processor 1 selects, as an indication effect, a normal indication effect A1 which is reproduced at normal speed and displays the selected effect on the display 2. The information processor 1 then selects, as a payout effect, a normal payout effect B1 which is reproduced at normal speed, and displays the selected effect on the display 2.

As shown in FIG. 1, when the predetermined condition is satisfied, the information processor 1 selects, as an indication effect, a speed indication effect A2 in which the normal indication effect A1 is reproduced at higher speed than the normal indication effect A1, and displays the selected effect on the display 2. The information processor 1 then selects, as a payout effect, a speed payout effect B2 in which the normal payout effect B1 is reproduced at higher speed than the normal payout effect B1, and displays the selected effect on the display 2.

As such, the information processor 1 includes the display 2 on which the slot game is displayed and the flash memory 104 which stores a normal effect and a high-speed effect in which the normal effect is reproduced at higher speed than the normal effect in association with a game result. The information processor 1 is programmed to execute a process of internally and randomly determining a game result of the slot game, a process of selecting a normal effect associated with the game result and displaying the selected effect on the display 2 when a predetermined condition is not satisfied, and a process of selecting a high-speed effect associated with the game result and displaying the selected effect on the display 2 when the predetermined condition is satisfied.

With this arrangement, single execution of the slot game is finished earlier than usual, when the predetermined condition is satisfied. As a result, the number of times of execution of the slot game per unit time is increased without omitting the effects, and the game progress is speedier than usual.

In the present embodiment, the predetermined condition for displaying the high-speed effect is the use of an item in the slot game by a user. In this way, the effect is accelerated when the item is used by the user. On this account, whether to accelerate the effect can be determined by the user. In the present embodiment, a valid period is set for the item. An effect is accelerated in the slot game which starts during the valid period. The valid period of the item may be time or the number of times of execution of the slot game in the present embodiment.

In the slot game, symbol arrays scrolling in the symbol display area 21, the symbols rearranged in the symbol display area 21, etc., may be included in the effects. In other words, these images may be elements of an effect, and all images displayed on the display 2 may be accelerated.

(Mechanical Structure)

As described above, the information processor 1 includes a display 2 provided on the front surface of a housing 11 and a touch panel 5 provided throughout the display 2. While the information processor 1 is a smartphone in the present embodiment, the information processor 1 may be a mobile device or a desktop device. Examples of the information processor 1 include mobile information devices such as a portable computer, a laptop computer, a tablet PC, a wearable PC, and a PDA (Personal Data Assistant).

The display 2 is configured to be able to display images. The display method of the display 2 is, for example, liquid crystal, organic electroluminescence, CRT (Cathode Ray Tube), or plasma. The touch panel 5 makes it possible to detect the coordinates of a part touched by a user's finger or the like. The touch panel 5 adopts an already known technology such as electromagnetic induction and electrostatic capacity. The information processor 1 determines an object on the screen touched by the user, or the state of the touching such as swipe and the like based on coordinates detected by the touch panel 5. The information processor 1 then makes a response according to the determination result. Hereinafter, determination of an object which is the target of input from the user by the information processor 1 may be referred to as user's selection of or touch input to an object.

The touch panel 5 may not be provided throughout the display 2. For example, the touch panel 5 may be provided on the back side of the housing 11, which is opposite to the display 2. Alternatively, the touch panel 5 may be provided at part of the display 2.

Further, in the present embodiment, the touch panel 5 operates as an input device, and accepts a swipe input, a touch input, and the like; however, the present embodiment is not limited to this. For example, a microphone or a camera may be adopted as an input device, and may receive the user's voice or gesture as an instruction input.

(Electrical Structure)

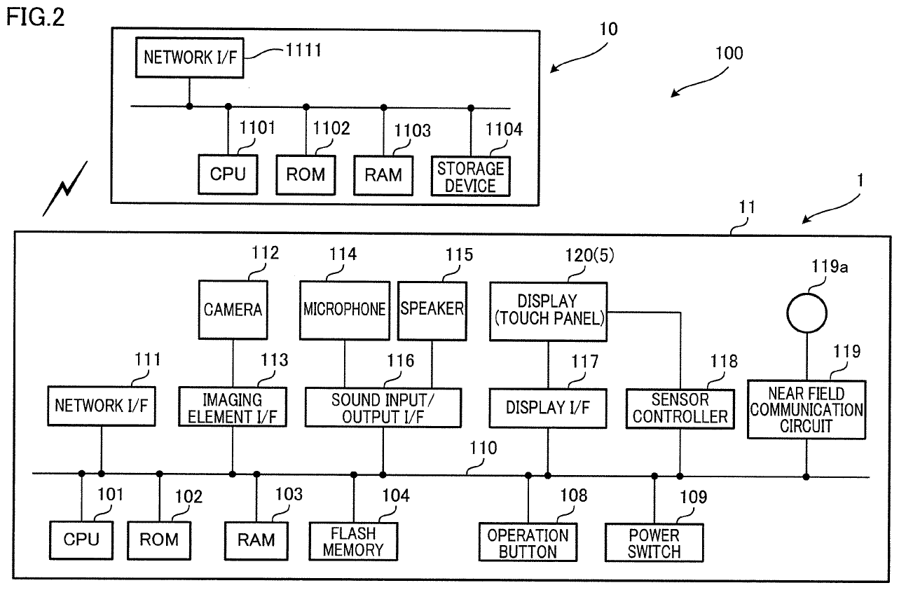

As shown in FIG. 2, the information processor 1 includes, in the housing 11, a CPU 101, a ROM 102, a RAM 103, a flash memory 104, an operation button 108, a power switch 109, a bus line 110, a network I/F 111, a camera 112, an imaging element I/F 113, a microphone 114, a speaker 115, a sound input/output I/F 116, a display I/F 117, a sensor controller 118, a near field communication circuit 119, and an antenna 119a of the near field communication circuit 119.

Further, the server 10 is a so-called computer including a CPU 1101, a ROM 1102, a RAM 1103, a storage device 1104 such as a hard disk drive and the like, and a network I/F 1111.

The CPU (Central Processing Unit) 101 functions as a main structure of the controller in the information processor 1, and controls the entire operation of the information processor 1. The CPU 1101 functions as a main structure of the controller in the server 10, and controls the entire operation of the server 10. The CPUs 101 and 1101 therefore function as controllers which control the entire operation of the game system 100. The ROM (Read Only Memory) 102 stores programs used for driving the CPU 101, such as an IPL (Initial Program Loader).

The RAM (Random Access Memory) 103 and the RAM 1103 are used as a work area of the CPU 101 and the CPU 1101. The operation button 108 is used for, for example, initial setting of the information processor 1. The power switch 109 is used for turning on/off the power source of the information processor 1.

The flash memory 104 as a memory is a non-transitory computer readable medium which stores the game program, a program for communication, and plural sets of data such as image data and sound data. The storage device 1104 is a non-transitory computer readable medium which functions as a database, and stores game data of each of the information processors 1. In response to a request from the game program in the information processor 1, the server 10 returns as needed a response referring to the database in the storage device 1104.

For example, the flash memory 104 stores various programs including a game program executed by the CPU 101 as a controller and various data used in the various programs. To put it differently, the game program stored causes the information processor 1 having the CPU 101 and the flash memory 104 to execute processes of programs. For example, when the information processor 1 is equivalent to the game system 100, the flash memory 104 (storage device 1104) stores various programs including a game program executed by the CPU 101 (CPU 1101) as a controller and various data used in the various programs. To put it differently, the game program stored causes the information processor 1 (game system 100) having the CPU 101 (CPU 1101) and the flash memory 104 (storage device 1104) to execute processes of programs. As such, the processes and operations of the information processor 1 can be interpreted as those of a program or a game control method.

The data and program in the flash memory 104 and the storage device 1104 may be stored in advance at the stage of factory shipment, or may be downloaded from an unillustrated server or the like via communication means and stored. The communication means may be an interactive communication passage such as the Internet and a cable TV, or may be one-way broadcasting. Alternatively, the data and program stored in the memory flash memory 104 and the storage device 1104 may be stored in a recording medium such as a floppy disk, a CD-ROM, a DVD-ROM, an MO (optical magnetic disc), and a flash memory, and may be read from the recording medium and installed in the memory according to need.

The network I/F (Interface) 111 and the network I/F 1111 are each an interface for data communications using a communication network such as the internet. The camera 112 is a built-in camera image capturing means which captures an image of an object to obtain image data under the control of the CPU 101. The imaging element I/F 113 is a circuit for controlling the camera 112. The microphone 114 is a built-in sound collection means to which sound is input. The sound input/output I/F 116 is a circuit for processing input and output of a sound signal between the microphone 114 and the speaker 115 under the control of the CPU 101. The display I/F 117 is a circuit for sending image data to the display 2 under the control of the CPU 101. The display 2 is provided on the front surface of the housing 11. The sensor controller 118 is a circuit for receiving an input from the touch panel 5 of the display 2. The near field communication circuit 119 is a communication circuit based on NFC (Near Field Communication)(Registered Trademark). Bluetooth (Registered Trademark), or the like. The bus line 110 is an address bus, a data bus, or the like for electrically connecting the components such as the CPU 101.

### Slot Game: Definitions

The slot game is playable by a user as a game element of the installed application software. The slot game is a game in which symbols are varied and then stopped in the symbol display area 21 (rearrangement) and a gaming value is awarded based on a combination of symbols displayed in the symbol display area 21. A state in which symbols are displayed after being varied and stopped in the symbol display area is termed “rearrangement”. In the slot game, a bonus game advantageous for the player as compared to the normal game may be executed when the normal game is executed and a predetermined condition is satisfied in the normal game.

A gaming value is used as a substitute for credits in the game, and is used for betting as a condition to execute the slot game. That is, a user plays the slot game (unit game) once by betting a gaming value, and may acquire a gaming value as a result of the slot game.

The “unit game” is a series of operations from the start of the receiving of a bet to a state in which an award can be established. To put it differently, the unit game includes a single bet time for receiving a bet, a single game time of rearranging stopped symbols, and a single payout time of a payout process of awarding a payout.

(Slot Game: Functional Blocks)

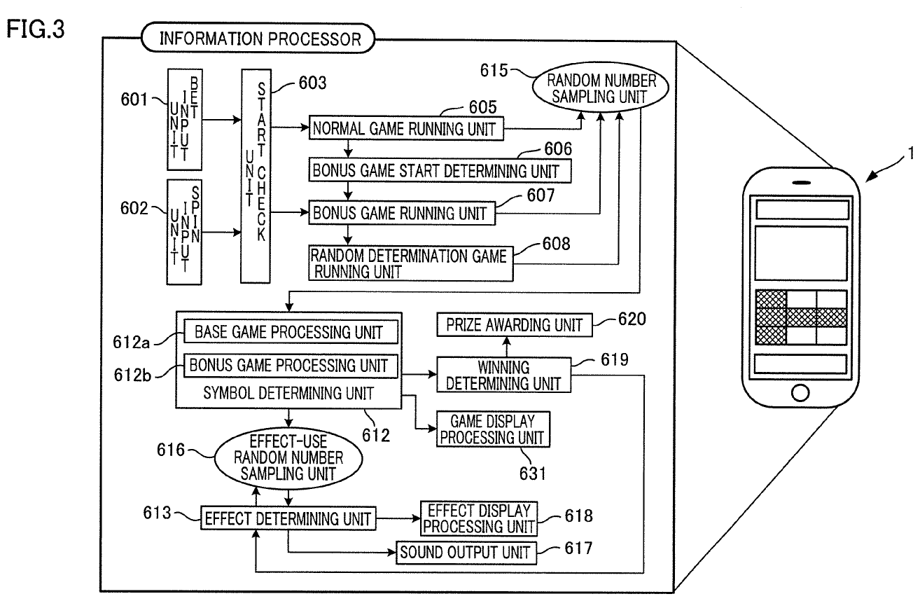

As shown in FIG. 3, the terminal device 1 which is a gaming machine running the slot game has the following functions. To be more specific, the terminal device 1 includes a BET input unit 601 and a spin input unit 602. The BET input unit 601 and the spin input unit 602 are kinds of input devices. The BET input unit 601 has a function of receiving a bet in response to a user operation. The spin input unit 602 has a function of receiving a user operation, i.e., an instruction to start a game.

The information processor 1 includes a start check unit 603, a normal game running unit 605, a bonus game start determining unit 606, a bonus game running unit 607, a random determination game running unit 608, a random number sampling unit 615, a symbol determining unit 612, an effect-use random number sampling unit 616, an effect determining unit 613, a sound output unit 617, an effect display processing unit 618, a winning determining unit 619, a prize awarding unit 620, and a game display processing unit 631.

The normal game running unit 605 has a function of running a normal game which is a base game, on condition that the BET input unit 601 is operated. The bonus game start determining unit 606 determines whether to run a bonus game, based on a combination of rearranged symbols resulted from the normal game. In other words, the bonus game start determining unit 606 has functions of: determining that the player is entitled to a bonus game when a bonus trigger condition is established; and activating the bonus game running unit 607 so as to run a bonus game from the subsequent unit game. The random determination game running unit 608 has a function of randomly determining prizes including the bonus game. As this function is executed after the execution by the bonus game running unit 607, the bonus game can be repeatedly run.

The symbol determining unit 612 includes a base game processing unit 612a and a bonus game processing unit 612b. The symbol determining unit 612 including these processing units 612a and 612b has functions of: determining symbols to be rearranged based on a random number given from the random number sampling unit 615; rearranging the determined symbols in the symbol display area 21 of the display 2; outputting rearrangement information of the symbols to the winning determining unit 619; and outputting an effect instruction signal to the effect-use random number sampling unit 616, based on the combination of the rearranged symbols.

The effect-use random number sampling unit 616 has functions of: when receiving the effect instruction signal from the symbol determining unit 612, extracting an effect-use random number; and outputting the effect-use random number to the effect determining unit 613. The effect content determining unit 613 has functions of: determining an effect content by using the effect-use random number; outputting image information on the determined effect content to the effect display processing unit 618; and outputting audio and illumination information of the determined effect content to the sound output unit 617.

The winning determining unit 619 has functions of: determining whether a winning is achieved based on a combination of symbols when rearrangement information of the symbols is given; calculating an amount of payout based on a winning combination formed when it is determined that a winning has been achieved; and outputting, to the prize awarding unit 620, a payout signal which is based on the payout amount. The prize awarding unit 620 has a function of paying out a gaming value to the user.

When, for example, the information processor 1 executes the indication effect based on the ratio of a payout amount to a bet amount, the winning determining unit 619 may have a function of outputting the payout amount to the effect content determining unit 619. The effect content determining unit 619 may have a function of requesting the effect-use random number sampling unit 616 to send a random number for determining the indication effect, when the ratio of the payout amount to the bet amount meets the condition of executing the indication effect. The effect content determining unit 619 may have a function of determining the indication effect based on the random number.

To be more specific, the effect content determining unit 613 has a function of determining an effect content, determining whether the predetermined condition is satisfied (in the present embodiment, whether an item used by the user is valid), and selecting the normal effect or the high-speed effect to be displayed.

Though not shown, the outputted contents by each of the above processing units is suitably transmitted to the server 10 connected via a communication line.

While processes and actions are described in the present embodiment with the assumption that the information processor 1 which is a smartphone has the functions above, the functions may be distributed to the components of the game system 100. For example, random determination of a result of the slot game may be performed by the server 10.

(Slot Game: Game Contents)

As the slot game, the information processor 1 has two game modes, namely a normal game mode and a bonus game mode. The normal game mode is a game state during the normal game, whereas the bonus game mode is equivalent to a game state in the free game. The information processor 1 shifts to the bonus game mode when the unit game is run in the normal game mode and a bonus trigger condition is satisfied in the normal game mode. The trigger of the bonus game is, for example, a condition in which three or more bonus symbols appear (are rearranged). The trigger of the bonus game may be another condition.

(Slot Game: Game Contents: Normal Game Mode)

The normal game mode is specifically described. In the game area displayed on the display 2 (see FIG. 1), symbols for the slot game are rearrangeable on the video reels with 3 rows and 5 columns. In a betting process, a bet amount is selected by the user. The bet amount is, for example, selected from numbers such as 1, 2, 3, 5, and 10 by operating the bet button, or an input of a desirable number may be enabled. The resource generated by accumulating parts of bet amounts is termed jackpot.

Thereafter, in the game area, as the symbols are rearranged by varying (scroll-moving) and stopping (scroll-stop) the video reels, whether winning is achieved is determined. Then win determination is performed based on the state of the rearranged symbols. For example, a bonus game trigger is established when three or more bonus symbols are rearranged in the game area.

(Slot Game: Game Contents: Normal Game Mode: High-Probability Game and Low-Probability Game)

The slot game which is run in the normal game mode is one of two types of games, namely a high-probability game and a low-probability game. Although not illustrated, the information processor 1 uses different symbol arrays between the high-probability game and the low-probability game. In a high-probability-game video reel used in the high-probability game, the number of long symbols on the symbol array is larger than the number of long symbols on a low-probability-game video reel used in the low-probability game, in order to arrange the trigger of the bonus game to be easily established.

Each time the low-probability game is run in the normal game mode, the information processor 1 performs random determination for the shift to the high-probability game. When a win is achieved in the random determination, the information processor 1 changes the slot game executed in the normal game mode to the high-probability game. When the execution of the free game is finished in the bonus game mode, the information processor 1 sets the slot game in the subsequent normal game mode to be the high-probability game. In any case, the number of times of execution of the high-probability game is randomly determined. When the high-probability game is executed the determined number of times, the slot game thereafter is the low-probability game.

(Slot Game: Game Contents: Bonus Game Mode)

The normal game mode shifts to the bonus game mode when the trigger condition of the bonus game is established, and a free game process is executed, to begin with.

In the free game process, free game reel strips used in the free game are determined, and a predetermined number of times of execution of the free game is set. The reel strips for the free game and the number of times of execution of the free game may be randomly chosen from plural selected options.

As the free game is run, win determination is executed. This win determination may be identical with the win determination in the normal game. For example, when three or more bonus symbols appear in the game area again, a retrigger condition of the bonus game (free game) is established, and the number of times of execution of the free game is increased.

Thereafter, whether the free game ends is determined. If the remaining number of times of execution of the free game is not zero, the free game is run for the remaining number of times.

(Slot Game: Game Contents: Acceleration)

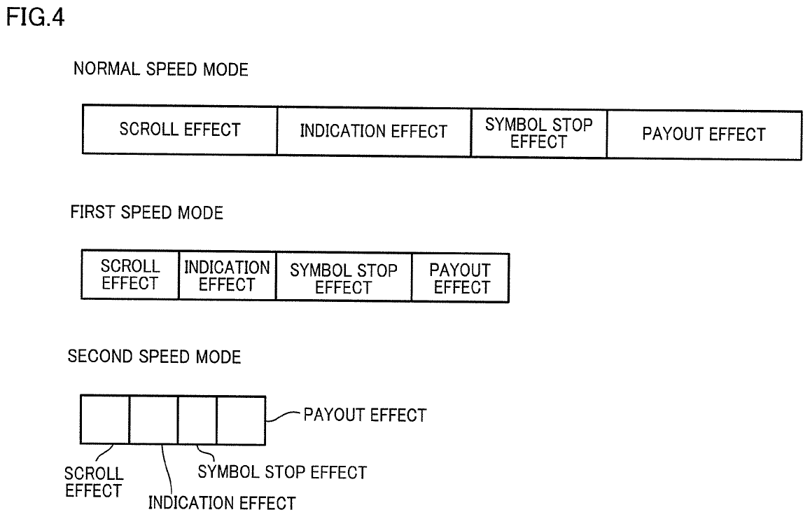

The acceleration in the slot game will be described with reference to FIG. 4. In the information processor 1 of the present embodiment, two type of items for acceleration, i.e., a speed item and a high-speed item are available for the user. Although not illustrated, each item can be used in an item use screen shifted from the slot game screen. Hereinafter, a state in which the speed item is valid is termed first speed mode. Furthermore, a state in which the high-speed item is valid is termed second speed mode. Furthermore, a state in which none of the items for acceleration is valid is termed normal speed mode.

FIG. 4 schematically shows a time chart which shows the time length of an effect element in each mode. The width of a box indicating each element corresponds to the time length. As shown in FIG. 4, elements in the slot game are a scroll effect, an indication effect, a symbol stop effect, and a payout effect. In the first speed mode, the symbol stop effect is identical in effect time with the symbol stop effect in the normal speed mode, and the normal effect is reproduced. In the first speed mode, furthermore, the scroll effect, the indication effect, and the payout effect are a half as long as those in the normal speed mode in terms of effect time. As such, the normal effect is reproduced at double reproduction speed. Hereinafter, an effect which is reproduced at double reproduction speed will be referred to as a first high-speed effect. The scroll effect indicates an effect of scroll from the start to stop of the rotation of a reel. The indication effect is displayed during scroll to indicate a game result before the symbols stop. In other words, the indication effect is displayed temporally in parallel to the scroll effect. The time of the scroll effect is therefore increased by the time of the indication effect. Alternatively, for example, the indication effect may be executed while the scroll effect is interrupted. After the indication effect, the symbol stop effect may be performed without the scroll effect. The symbol stop effect is an effect of symbols displayed after the stop of the scroll. For example, an effect of an animation of stopped symbols is performed. The payout effect is an effect of displaying an image of a payout obtained in the slot game. As shown in FIG. 1, when a payout which is predetermined times or more as much as the betting is awarded, an effect may be performed such that a large image indicating the payout which is predetermined times or more is provided on the symbol display area 21 (FIG. 1).

In this way, in the first speed mode, the information processor 1 selects an effect element for which the high-speed effect is performed, from effect elements of the effects displayable in the slot game. Because the information processor 1 determines whether to display a high-speed effect for each effect element, it is possible to increase or decrease the number of effect elements for each of which the high-speed effect is performed, in accordance with a satisfied condition. It is therefore possible to set the time required for the slot game in accordance with a condition.

In the second speed mode, all effect elements are a quarter as long as those in the normal effect in terms of effect time as compared to the normal speed mode. As such, the normal effect is reproduced at quadruple reproduction speed. Hereinafter, an effect which is reproduced at quadruple reproduction speed will be referred to as a second high-speed effect.

As described above, the information processor 1 stores plural high-speed effects which are different in speed in association with a normal effect, and selects one of the high-speed effects associated with a game result, in accordance with the item used by the user. In other words, there are plural types of items for acceleration, and the acceleration of an effect is changed in accordance with the item used by the user. This allows the user to play the slot game with an effect with desired speed.

(Data Table)

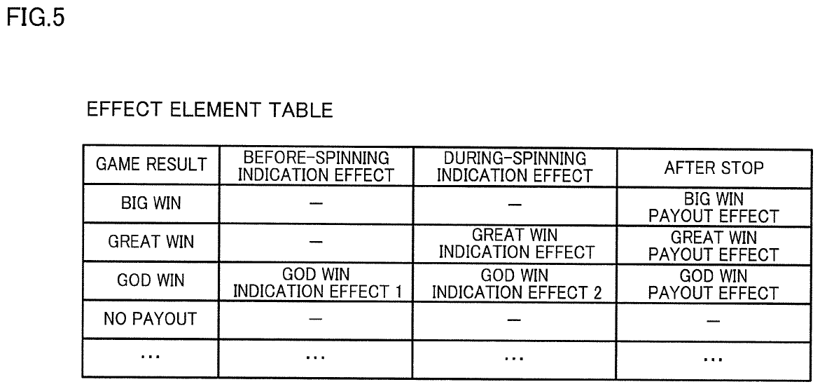

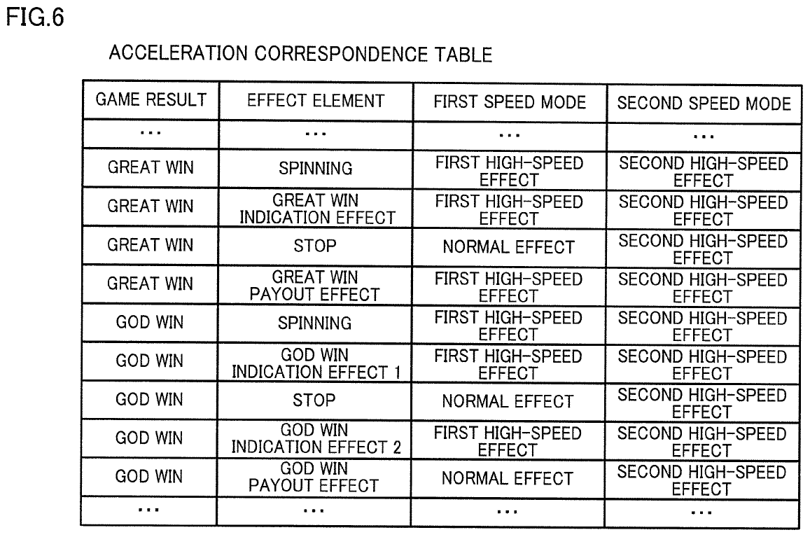

The following describes a data table stored in the information processor 1. The flash memory 104 of the information processor 1 stores the effect element table (see FIG. 5) and the acceleration correspondence table (see FIG. 6).

(Data Table: Effect Element Table)

As shown in FIG. 5, the effect element table includes a game result column and plural effect element columns. The game result column stores game results of the slot game. “BIG WIN” shown in FIG. 5 indicates that the ratio of a payout to a bet amount is equal to or more than 20:1 and less than 50:1. “GREAT WIN” indicates that the ratio of a payout to a bet amount is equal to or more than 50:1 and less than 100:1. “GOD WIN” indicates that the ratio of a payout to a bet amount is equal to or more than 100:1.

Each effect element column indicates a timing of an effect in the slot game. Each effect element column stores effect elements performed at the timing. When nothing is stored in the effect element column, no effect is performed at that timing. The table does not include effect elements which are always performed, such as the spinning of symbol arrays and the stop of symbols.

For example, when a game result is “BIG WIN”, no indication effect is performed before and during the spinning, and only the payout effect after the stop is performed. When a game result is “GOD WIN”, the indication effect is performed before and during the spinning, and the payout effect is performed after the stop. In other words, after a game result is determined based on the random determination before the spinning, the information processor 1 determines an effect element which is to be performed as an effect, with reference to the effect element table.

(Data Table: Acceleration Correspondence Table)

As shown in FIG. 6, the acceleration correspondence table includes a game result column, an effect element column, a first speed mode column, and a second speed mode column. The game result column stores game results of the slot game. In the effect element column, effect elements stored in the effect element columns of the effect element table (see FIG. 5) are stored. In the first speed mode column and the second speed mode column, at which reproduction speed each element is reproduced is indicated as “normal effect”, “first high-speed effect”, or “second high-speed effect”.

For example, when a game result is “GOD WIN” and the first speed mode is set, the normal effect which is performed at the normal reproduction speed is selected for the symbol stop and the payout effect. For the indication effect during, before, and after the spinning of the symbol arrays, the first high-speed effect which is performed at the double reproduction speed as compared to the normal effect is selected. When a game result is “GOD WIN” and the second speed mode is set, the second high-speed effect which is performed at the quadruple reproduction speed as compared to the normal effect is selected for the indication effect before the spinning, the spinning of the symbol arrays, the indication effect during the spinning, the stop of the symbols, and the payout effect.

(Operations)

The following will describe a game program executed by the CPU 101 of the information processor 1.

(Operation: Slot Game Process)

The following describes a game program in a slot game process executed by the CPU 101 of the information processor 1.

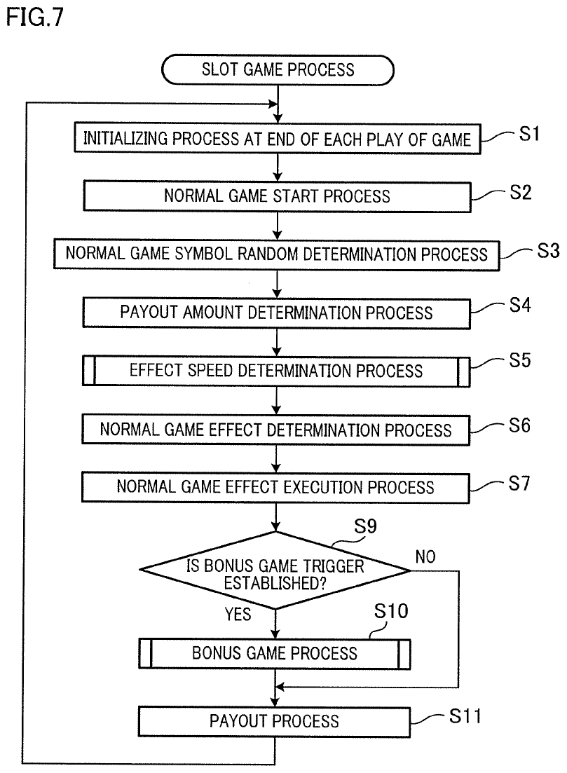

As shown in FIG. 7, the CPU 101 executes an initializing process at the end of each play of the game (S1). For example, the CPU 101 clears data in a working area of the RAM 103, which becomes unnecessary at the end of each play of game, e.g., the bet amount and symbols selected by random determination. The CPU 101 then executes a normal game start process (S2). In the normal game start process, the CPU 101 checks a bet amount input through the touch panel 5, for example. The CPU 101 then executes a normal game symbol random determination process (S3). In this process, the CPU 101 randomly selects and determines symbols 500 to be stopped based on a random number, with reference to a symbol array table for the video reels.

Subsequently, the CPU 101 executes a payout amount determination process (S4). To be more specific, the CPU 101 determines whether a winning combination is established on a selected payline and a win is achieved, and determines a payout amount for each of all wins regarding the payline, when a win is achieved. The CPU 101 further determines whether the bonus game is triggered. The CPU 101 then executes an effect speed determination process (S5). This effect speed determination process will be described later.

Subsequently, the CPU 101 executes a normal game effect determination process (S6). Subsequently, the CPU 101 executes a normal game effect execution process (S7). In this process, based on the indication effect determined in the step S5 and the step S6, the CPU 101 performs control such as displaying the effect on the display 2 and outputting sound from the speaker 115.

Subsequently, based on the result of the step S4, the CPU 101 determines whether the bonus game trigger is established (S9). When the bonus game trigger is established (YES in S9), the CPU 101 executes a bonus game process (S10).

Meanwhile, when the bonus game trigger is not established (NO in S9) or after the bonus game process in the step S10, the CPU 101 executes a payout process (S11). To be more specific, the CPU 101 adds a value stored in the payout amount storage area to a value stored in a credit amount storage area (credit counter) provided in the RAM 103. Then the CPU 101 executes the steps again from S1.

(Bonus Game Process)

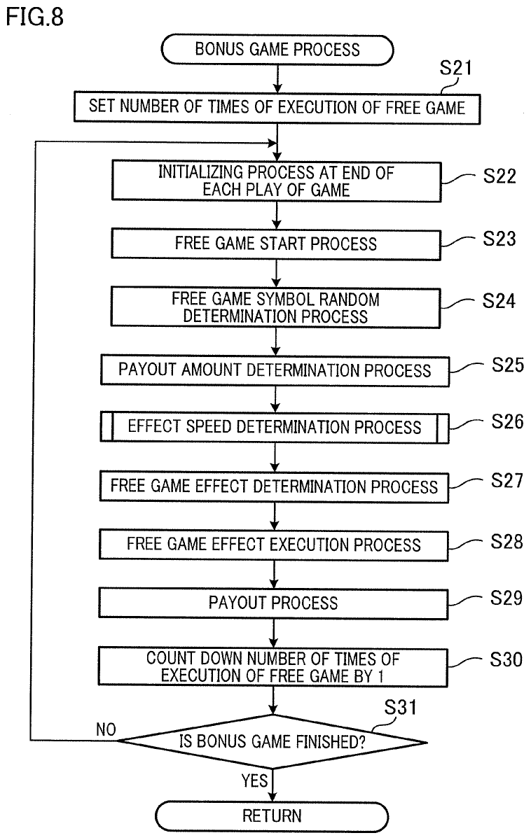

With reference to FIG. 8, the following describes the game program in relation to the bonus game process which is a sub routine of the slot game process executed by the CPU 101 of the information processor 1.

To begin with, the CPU 101 sets the number of times of execution of the free game (S21). For example, the CPU 101 sets the number of times of execution of the free game at 5. Thereafter, the CPU 101 executes an initializing process at the end of each play of the game (S22). For example, the CPU 101 clears data in a working area of the RAM 103, which becomes unnecessary at the end of each play of game, e.g., symbols selected by random determination. It is noted that the bet amount in the bonus game is identical with the bet amount in the normal game immediately before the shift to the bonus game.

Thereafter, in the same manner as in the normal game, the CPU 101 executes a free game start process (S23), a free game symbol random determination process (S24), a payout amount determination process (S25), an effect speed determination process (S26), a free game effect determination process (S27), a free game effect execution process (S28), and a payout process (S29).

In the free game, a symbol random determination table for the free game, which is different from the symbol array table for the first video reel and the symbol array table for the second video reel used in the normal game, may be used. The symbol random determination table for the free game is preferably more advantageous than the tables used in the normal game. For example, in the symbol array table for the first video reel in the free game, the percentage of symbols related to a winning combination with a large payout amount is high (or the probabilities of stop of such symbols are high), the number of wild symbols is large (or the probabilities of stop of such symbols are high), or the number of bonus symbols is large (or the probabilities of stop of such symbols are high). In the symbol column table for the second video reel in the free game, for example, the number of special symbols 510 is large (or the probabilities of stop of such symbols are high) as compared to the video reel in the normal game.

Subsequently, the CPU 101 decrements the current number of times of execution of the free game by one (S29). Then the CPU 101 determines whether the bonus game has been finished (S30). When the number of times of execution of the free game is not 0 (NO in S30), the CPU 101 determines that the bonus game has not been finished, and executes the free game again from the step S22. Meanwhile, when the number of times of execution of the free game is 0 (YES in S30), the CPU 101 determines that the bonus game has been finished, and ends the sub routine and returns to the slot game process.

Although not illustrated, when the payout amount is determined in each of the slot game process and the bonus game process, the CPU 101 executes a process of sending the payout amount to the server 10 as an acquired amount.

(Effect Speed Determination Process)

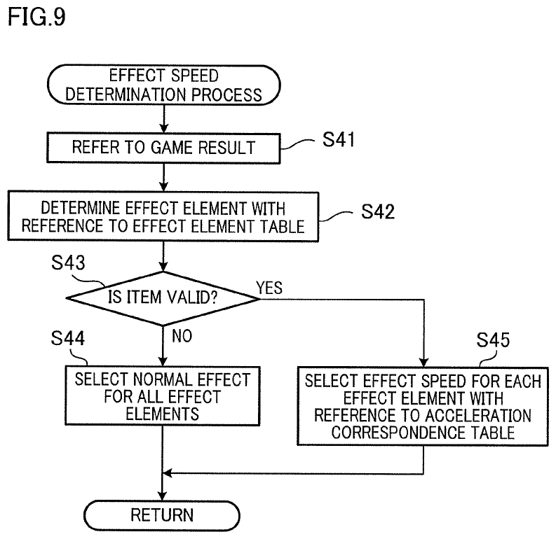

With reference to FIG. 9, the following describes a game program in relation to the effect speed determination process which is a sub routine of the slot game process and the bonus game process executed by the CPU 101 of the information processor 1.

To begin with, the CPU 101 refers to a game result (S41). In other words, the CPU 101 refers to a game result based on the normal symbol random determination process and the payout amount determination process in the slot game process and the free game symbol random determination process and the payout amount determination process in the bonus game process. The CPU 101 then determines an effect element corresponding to the game result with reference to the effect element table (see FIG. 5) (S42).

The CPU 101 then determines whether an item for acceleration is valid (S43). When the item for acceleration is not valid (NO in S43), the normal effect in the normal speed is selected for all effect elements determined in the step S42 (S44). Then the CPU 101 terminates the routine.

When the item for acceleration is valid (YES in S43), effect speed is determined for each effect element with reference to the acceleration correspondence table (see FIG. 6) (S45). Then the CPU 101 terminates the routine.

(Acceleration Item Management Process)

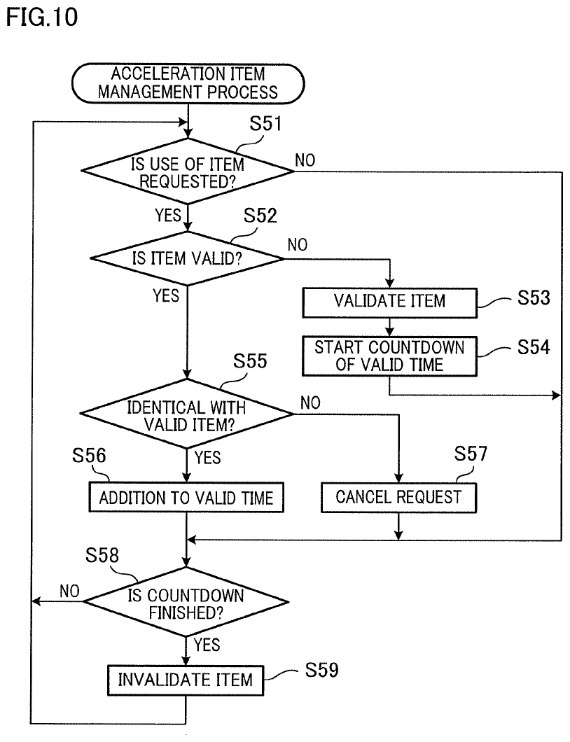

With reference to FIG. 10, the following describes a game program in relation to an acceleration item management process executed by the CPU 101 of the information processor 1. The acceleration item management process is executed independently from the slot game process (see FIG. 7).

To begin with, the CPU 101 determines whether the use of an item has been requested (S51). In other words, the CPU 101 determines whether an input indicating the use of an item has been made to the touch panel 5 by the user.

When the use of an item has been requested (YES in S51), the CPU 101 determines whether the item is currently validated (S52). When the item is not currently validated (NO in S52), the CPU 101 validates the requested item (S53) and starts to count down the valid period of the item (S54).

Meanwhile, when the item has been validated (YES in S53), whether the requested item is identical with the validated item is determined (S55). When the requested item is identical with the validated item (YES in S55), the CPU 101 adds the valid time set in the item to be used to the valid time being counted down (S56). When the requested item is not identical with the validated item (NO in S55), the request to use the item is refused (S57).

When the use of an item is not requested in the step S51 (NO in S51) or after the step S54, S56, or S57, the CPU 101 determines whether the countdown of the valid time has been finished (S58). When the countdown has not been finished (NO in S58), the CPU 101 proceeds to the step S51. When the countdown has been finished (YES in S58), the CPU 101 invalidates the item (S59) and proceeds to the step S51. Although not illustrated, the CPU 101 causes the display 2 to always display the countdown.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to for the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. An information processor comprising: a display configured to display a slot game;
a memory configured to store a normal effect and a high-speed effect in which the normal effect is reproduced at higher speed than the normal effect, in association with a game result; and
a controller, the controller being programmed to execute the processes of:
internally and randomly determining a game result of the slot game;
when a predetermined condition is not satisfied, selecting the normal effect associated with the game result and displaying the normal effect on the display; and
when the predetermined condition is satisfied, selecting the high-speed effect associated with the game result and displaying the high-speed effect on the display.

2. The information processor according to claim 1, wherein the predetermined condition is use of an item usable in the slot game by a user.

3. The information processor according to claim 2, wherein, the memory stores high-speed effects of different types for the normal effect, and
the controller selects one of the high-speed effects associated with the game result, in accordance with the item used by the user.

4. The information processor according to claim 1, wherein, an effect displayed in the slot game is constituted by a plurality of effect elements, and
when the predetermined condition is satisfied, the controller selects an effect element for which the high-speed effect is displayed, from the effect elements.

5. A non-transitory computer readable recording medium storing a game program,
the game program causing
a computer including a display and a memory to execute the processes of:
displaying a slot game on the display;
storing, in the memory, a normal effect and a high-speed effect in which the normal effect is reproduced at higher speed than the normal effect, in association with a game result;
internally and randomly determining a game result of the slot game;
when a predetermined condition is not satisfied, selecting the normal effect associated with the game result and displaying the normal effect on the display; and
when the predetermined condition is satisfied, selecting the high-speed effect associated with the game result and displaying the high-speed effect on the display.

6. A game control method executed by a computer including a display on which a slot game is displayed and a memory configured to store a normal effect and a high-speed effect in which the normal effect is reproduced at higher speed than the normal effect, in association with a game result,
the method comprising the steps of:
internally and randomly determining a game result of the slot game;
when a predetermined condition is not satisfied, selecting the normal effect associated with the game result and displaying the normal effect on the display; and
when the predetermined condition is satisfied, selecting the high-speed effect associated with the game result and displaying the high-speed effect on the display.
